(19) United States
(12) Patent Application Publication
(10) Pub. No.: US 2005/0160155 A1
(43) Pub. Date: Jul. 21, 2005

(54) Method and apparatus for dynamic rendering of services

(76) Inventors: Harpreet Geekee, Kanata (CA); David Tweedie, Stittsville (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/740,410

(22) Filed: Dec. 22, 2003

(51) Int. Cl. G06F 15/177

(52) U.S. Cl. 709/220

(57) ABSTRACT

For communication systems, irrespective of the network intelligence model employed, some embodiments of the invention provide the ability to add and/or remove services based on dynamic real-time changes in end-user status, location and/or privileges. According to such embodiments new services are described in generalized application description files that are rendered into native software applications within end-user devices. Application description files are made up of relatively small amounts of data in comparison to full-blown software applications used to implement services in the past. This is particularly advantageous in the wireless market where, since bandwidth is limited, the data to be downloaded to end-user devices should be kept as small as possible.

### FIELD OF THE INVENTION

This invention relates generally to communication services and, in particular, to methods and apparatus of delivering services.

### BACKGROUND

In a communication system, services can be implemented in the form of software applications that are made up of various functions and feature sets that are enabled by service capabilities designed into the communication system. A particular service can be either a network or data service that makes use of underlying network service capabilities. The service capabilities (e.g. service logic, operation and management, fault tolerance, etc.) are generalized software abstractions of underlying implementation complexity and they form the basic building blocks of higher level services.

Current communication services are almost exclusively available and processed on core network elements such as web servers or application servers co-located with base-stations or network access nodes. The end-user devices are considered non-intelligent because they do not typically process the software applications that implement any particular service.

Several examples of this type of centralized processing/intelligence scheme exist within 2G and 2.5G cellular wireless communication systems. One such example of such a service is Intelligent Call Routing, which has logic that resides and is processed completely within a core communication network element. The end-user devices operating within these systems are not expected to support very sophisticated services beyond basic voice, Dual-Tone Multi-Frequency (DTMF) user interaction and/or simple text messaging.

Centralized processing/intelligence schemes provide few options for third party services development. New software-based services must be precompiled and tailored specifically to work properly on a number of different operating platforms available to end-users in addition to the core network elements. This requirement causes third party service development and deployment to be slow and introduces inconsistencies in the quality of services that a network operator may choose to provide.

An alternative approach is to develop (internet-like) browser-based services. Browser-based services can be created independent of device or operating platform technologies. The technology independence of browser-based services is enabled by the fact they are restricted from accessing underlying device technologies specific to each manufacturer of end-user devices and/or core network elements. However, a drawback is that browser-based services are limited in complexity since a full array of service capabilities can not be exploited.

Third party services (software) development is further complicated by an industry trend towards a de-centralized intelligence model, in which service intelligence is distributed away from core network elements towards end-user devices. As a result, next generation services will be made-up of client software and network server software.

Generally, regardless of the network intelligence model, new services need to be recompiled and reloaded onto end-user devices, which requires network operators to provide and maintain multiple copies of the same services for use on different operating platforms available to end-users.

### SUMMARY OF THE INVENTION

According to a first aspect of an embodiment of the invention there is provided a system having a file repository storing at least one application description file, the at least one application description file containing a description of at least one service. The system also has an end-user device adapted to provide access to communication services for an end-user. The end-user device is adapted to download the at least one application description file from the file repository, the end-user device having underlying network service client components, and the end-user device having interpreting, rendering and binding logic that interprets and renders the at least one application description into a software application and binds the software application to underlying network service client components residing on the end-user device.

In such embodiments the end-user device is further adapted to operate within a service provider access network comprising at least one of a cellular wireless infrastructure, a wireline communication system infrastructure, an optical communication system infrastructure, a Local Area Network (LAN) communication system infrastructure and a Wide Area Network (WAN) communication system infrastructure.

Accordingly, in some embodiments, the system further comprising said service provider access network, wherein the service provider access network obtains the at least one application description file from the file repository and downloads the at least one application description file to the end-user device. In some embodiments at least one of the end-user device, the service provider access network and the file repository is connectable to a private communication network so that the end-user device can access the file repository through the combination of the service provider access network and the private communication network. In other embodiment the at least one of the end-user device, the service access provider network and the file repository is connectable to an internet so that the end-user device can access the file repository through the combination of the service provider access network and the internet.

In some embodiments, a trigger is used in a determination of whether or not the at least one application description file is to be downloaded to the end-user device. In some other embodiments a trigger is used by the service provider access network to determine whether or not the at least one application description file is to be downloaded to the end-user device. In some embodiments the trigger is forwarded to the file repository in response to which the file repository downloads the at least one application description file to the end-user device.

In some embodiments, for a subscriber having a respective end-user device, after the application description file has been downloaded and rendered into the corresponding software application, a trigger is used in a determination of whether or not a software application rendered from the at least one application description file is to be removed from the respective end-user device.

According to a second aspect of an embodiment of the invention there is provided a end-user device for use in a communication system providing additional services through the use of respective application description files that contains descriptions of corresponding services. The end-user device has: a native Operating System (OS) serving as the operating platform for the end-user device; a receiver for receiving application description files through the communication system; underlying network service client components that enable the use of network services on the end-user device; and interpreting, rendering and binding logic that interprets and renders the application description files into corresponding rendered software applications, and then binds the rendered software applications to the underlying network service client components residing on the end-user device, the software applications providing the additional services on the end-user device.

In some embodiments, the interpreting, rendering and binding logic comprises an adaptive service Application Program Interface (API) that is made up a set of operational parameters that link the thin client and rendered software applications to at least one of the native OS and the network service client components.

In some embodiments the interpreting, rendering and binding logic comprises software component libraries that are made-up of number of generic pre-compiled software functions and feature sets that can be combined in a number of ways to produce different software applications.

In some embodiments the interpreting, rendering and binding logic comprises an abstraction layer for interpreting and then rendering the contents of application description files into rendered software applications and binding them to the native OS and the underlying network service client components. In related embodiments the abstraction layer is further adapted to un-bind rendered software applications from the native OS and the underlying network service client components when signalled to do so.

According to a third aspect of an embodiment of the invention there is provided a file repository for storing an application description file for access by an end-user device operable within a communication system and having interpreting, rendering and binding logic, and the file repository comprising a data structure stored in the file repository, the data structure including a description of a service for use in the communication system.

According to a fourth aspect of an embodiment of the invention there is provided a computer readable medium for storing an application description file for access by an end-user device operable within a communication system and having interpreting, rendering and binding logic, and the computer readable medium comprising a data structure that includes a description of a service for use in the communication system.

According to a fifth aspect of an embodiment of the invention there is provided a computer readable medium comprising processed readable instructions for execution by an end-user device, the instructions comprising interpreting, rendering and binding logic that interprets and renders the application description files into corresponding rendered software applications, and then binds the rendered software applications to underlying network service client components residing on the end-user device, the software applications providing the additional services on the end-user device.

According to a sixth aspect of an embodiment of the invention there is provided a method of dynamically downloading and rendering a service within a communication system onto an end-user device. The method includes the end-user device downloading an application description file, the application description file describing the service; and the end-user device interpreting and rendering the application description file to produce a corresponding software application from software component libraries stored on the end-user device, and binding the corresponding software application to underlying network service client components residing on the end-user device enabling the use of the service on the end-user device.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is system diagram of an example of a communication system provided by an embodiment of the invention;

FIG. 2 is a block diagram of the software architecture provided within an end-user device shown in FIG. 1 provided by an embodiment of the invention;

FIG. 3 is a flow chart outlining an example life cycle of a new service developed in accordance with an embodiment of the invention;

FIG. 4A is a system illustration depicting a sequence of events for a new service addition to an end-user device and then its subsequent removal according to one specific embodiment of the invention; and

FIG. 4B is a flow-chart corresponding to the system illustration of FIG. 4A.

### DETAILED DESCRIPTION OF THE PREFERRED EMBODIMENTS

Typical software development approaches do not provide the ability to add/remove services based on dynamic real-time changes in end user status, location and/or privileges. That is, the available options for third party services development do not provide the ability to dynamically download and integrate new software based services on a variety of end-user devices from different manufactures. Moreover, in the wireless market bandwidth is limited so in any solution that involves downloading services onto an end-user device it is preferable that the data to be downloaded be kept as small as possible.

For communication systems, irrespective of the network intelligence model employed, some embodiments of the invention provide the ability to add and/or remove services based on dynamic real-time changes in end-user status, location and/or privileges. That is, some embodiments of the invention provide a way of quickly and dynamically deploying services within a communication system. A subsequent removal of a service may be instigated as a result of any number of possible events, such as, but not limited to, an explicit un-binding request by the end-user, an expiration of a particular time interval, a request to un-bind the application received from the network, a network event and/or shutting off the end-user device. More generally, triggering the deployment and/or removal of a service can either occur in real-time, after a pre-defined duration of time or as a result of some other trigger event such as a real-time change in end-user status, location and/or privileges.

In some embodiments of the invention, a trigger is any stimulus that can be received by a communication network element that indicates some change in relation to the end-user and/or end-user device. Once a trigger is sensed by a communication network element, in some embodiments, a message is sent from the communication network element to other communication network elements that help to provide a new service. With respect to the examples discussed further below a trigger can be sensed and shared by anyone of an end-user device, a service provider access network (or the like) or a third party element connected to a communication system. Those skilled in the art would appreciate that any apparatus operable to communicate with another apparatus could sense and share a trigger in the form of a message.

According to one very specific example, a base-station providing a particular service different from adjacent base-stations, may detect the presence of an end-user device within its coverage area and “push” the particular service onto the end-user device. In such an example the trigger is the location of the end-user device within the coverage area of the base-station. In other examples the end-user device may “pull” a new service from the base-station, once provided with knowledge of the new service.

If a trigger originates from a communication network element (e.g. a base-station, web-server, etc.), then, in some embodiments, the communication network element shares the trigger with an end-user device. A respective message that shares knowledge of the trigger could originate from any number of network elements, either present in a service provider access network or third party network capable of sending messages to the end-user device. Examples of such triggers and/or trigger messages, originating from communication network elements, include: incoming-call requests, call terminations, SMPP (Short-Message Peer-to-peer Protocol) messages, IN (Intelligent Networks) events to which an end-user device is subscribed to, SIP messages, etc.

In other instances a trigger is actually sensed and shared by an end-user device. Examples of such triggers and/or trigger messages, originating from an end-user device, include: end-user device power-up (i.e. turning it on), power-down (i.e. turning it off), the end-user device changing to a dormant/idle state, or loss of connectivity to a network element (e.g. a base-station, web-server).

A trigger can even be sensed and shared by a combination consisting of at least one of hardware, firmware and software created for an end-user device that provides the functionality for enabling the end-user device to be operable within an ASE. With respect to the example embodiments discussed below, the trigger, in some embodiments, is sensed by a thin client residing on an end-user device and/or interpreting, rendering and binding logic residing on the end-user device. Examples of such triggers and/or trigger messages include: end-user device power-up (i.e. turning it on), power-down (i.e. turning it off), the end-user device changing to a dormant/idle state, or loss of connectivity to a network element (e.g. a base-station, web-server).

According to such embodiments new services are described in generalized (i.e. non-platform specific) application description files that are rendered into native software applications within end-user devices, thus removing the requirement for network operators to provide and maintain multiple copies of the same services for use on different proprietary operating platforms available to end-users. Unlike browser-based services, the newly rendered software applications have access to the underlying device and network service capabilities. Moreover, because the application description files are not full blown software applications they are made up of relatively small amounts of data that can be distributed around the communication system relatively quickly. This is particularly advantageous in the wireless market where, since bandwidth is limited, the data to be downloaded should be kept as small as possible.

In some instances, service interfaces described in application description files are used to open and configure new screens that are presented to the end-user in a format the end-user is familiar with. However, an application description file does not need to have, and it is undesirable for the application description file to contain too much information relating to the specifics of any particular type of end-user device. Keeping the application description file as general as possible greatly enhances the utility/usability of a new service and the speed with which new services can be deployed and old services retracted, with respect to a variety of types of end-user devices and a communication system as a whole.

Some embodiments of the invention, the ability to add and/or remove service is provide with an Adaptive Services Environment (ASE) implemented on end-user devices in response to real-time changes in the status, location and/or privileges of the end-user and/or end-user device.

In some embodiments the ASE is enabled by a thin client, which is provided on each end-user device that subscribes to a communication system (network). The thin client renders application description files into corresponding device specific (native) software applications through which an end-user can easily invoke service specific functions.

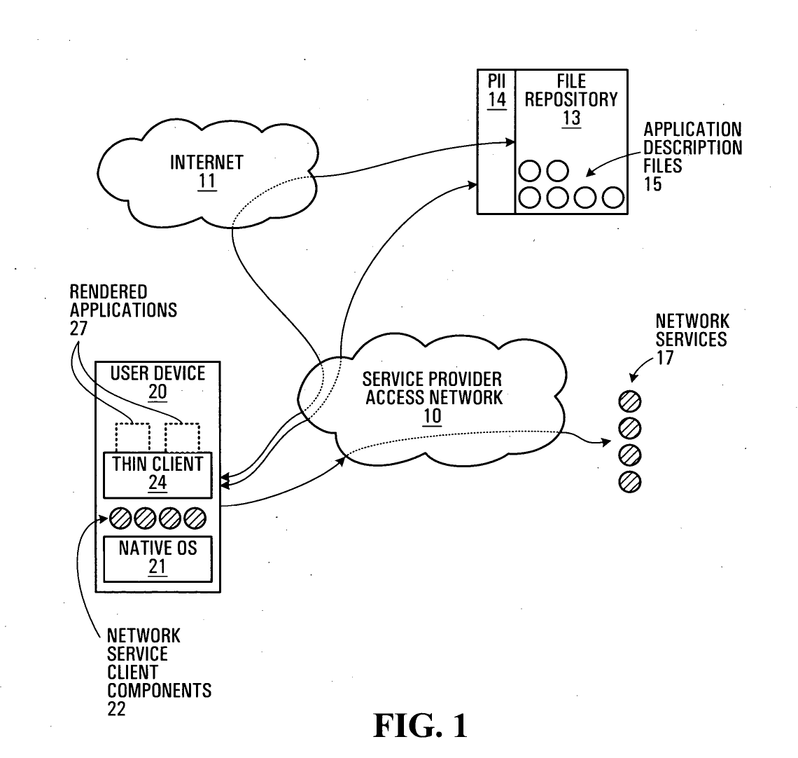

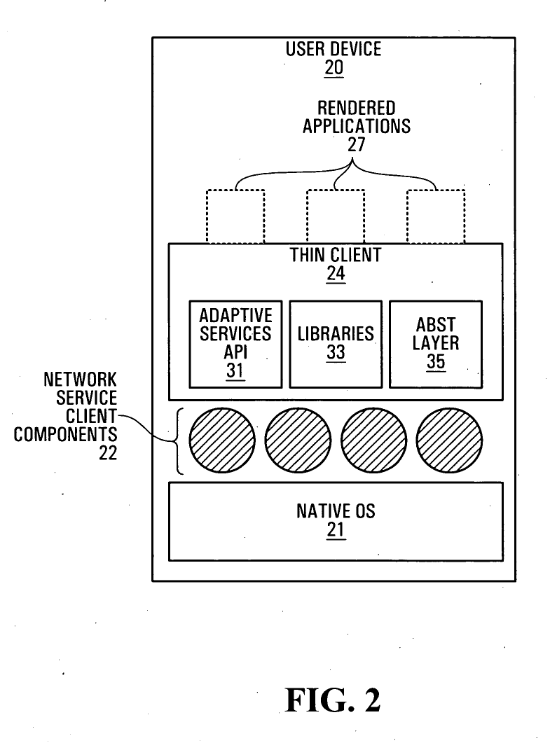

More specifically, according to some embodiments of the invention, end-users invoke services through the communication system (network) using an interface (e.g. the thin client) residing on the end-user device tailored to the communication system (network) and the specific underlying implementation of the end-user device. In this way services having customized interfaces can be provided to a variety of end-user devices without the service developer requiring any direct knowledge of any of the native protocols of different end-user devices. This in turn allows a network operator to provide services to end-users having different types of access devices (e.g. end-user devices such as cellular telephones, PDA's, PC's, etc.), where each type of end-user access (i.e. client) device may be supported via a different core network capability. The ASE interface to a communication network—in particular the thin client—will be described in detail further below with respect to FIGS. 1 and 2.

In some embodiments, the application description files are composed in an extensible Mark-up Language (XML) that is independent of technology and proprietary features exclusively licensed from any one manufacturer. The application description files written in an XML contain a description of the features, functions and characteristics that are related to the execution and delivery of services and/or network based applications. The use of an XML also permits the integration of additional content into the end-user device. In one example, this content is made-up of additional data and a set of actions that can be performed on the data. In other embodiments an XML file may be supplemented with a file written in a scripting language, which could be used to provide additional rudimentary logic associated with the corresponding service.

The fact that the ASE is provided on end-user devices permits service developers to create services in the form of software applications using enterprise application development toolkits that are available from a variety of vendors (such as IBM websphere, Borland's Jbuilder, BEA's webLogic, etc.). Service developers are freed from the requirement of having to re-write, re-design and re-configure services in the form of software applications, for each set of manufacturer specific device protocols and operating system available on end-user devices. The services can instead be developed according to end-user profiles and Operation, Administration, Management and Provisioning (OAMP) strategies of a communication system infrastructure. For example, application (i.e. service) deployment and management functionality can be handled by a Quality-of-Service (QoS) tool.

FIG. 1 shows a very specific example of a communication system according to an embodiment of the invention. The example communication system is made up of an internet 11, a service provider access network 10, a file repository 13 and an end-user device 20. The internet 11 is commonly understood to be a collection of publicly accessible data communication networks made up of various devices. The file repository 13 might for example be a server, a database, or some other devices capable of storing application description files 15 described below. In some embodiments the file repository 13 or a like device is associated with the service provider access network 10 and/or the internet 11. The end-user device 20 is representative of one of any number of devices that subscribe to the service provider access network 10.

The service provider access network 10 is typically a private network, such as a cellular wireless network, to which subscribers (i.e. end-users) may pay to access and use basic communication services through their own or rented end-user devices. The service provider access network 10 provides a number of network services 17 that enable the basic communication services. The network services 17 are invoked at the end-user device 20 through the use of network service client components 22 that reside in the end-user device 20. The service provider access network 10 can also optionally provide the end-user device 20 with access to the internet 11 and/or other private networks (not shown).

The end-user device 20 also includes a native Operating System (OS) 21, a thin client 24 and rendered applications 27. The network service client components 22 and these other software components of the end-user device will be described in more detail with respect to FIG. 2. Moreover, end-user device 20 and other such devices that subscribe to the service provider access network 10 are understood to include the necessary combination of hardware, firmware and software, like receivers and transmitters, that the particular device would use to access communication services.

Generally, it is to be understood that the service provider access network 10 can be based on any communication system standard that provides subscriber access and that the end-user device 20 is adapted or selected accordingly. That is, the embodiments of the invention and, in particular, the adaptive service environment is independent of communication system standard employed by the service provider access network 10. In some specific embodiments of the invention the service provider access network 10 operates according to one of: GPRS, UMTS, CDMA, 1X, PSTN and LAN/WAN.

The network services 17 (or service capabilities) are those services that are provided by the service provider access network 10. In order for the end-user device 20 to subscribe to the service provider access network 10 the end-user device 20 has a network service client component for each corresponding network service. Typical network services 17 include call origination/termination, SMS (Short Message Service), MMS (Maintenance Management Systems), SIP (Session Initial Protocols), presence, instant messaging, location services and directory services. Those skilled in the art would appreciate that numerous other services may be included for the operation of an end-user device within a communications system.

The file repository 13 is a repository for application description files 15, which in some embodiments are preferably written in an XML. The file repository 13 employs a path-independent interface 14 that allows an end-user device or a network server to retrieve the application description files 15. In some embodiments the path-independent interface 14 could be one of, but is not limited to, HTTP (HyperText Transfer Protocol), raw TCP (Transmission Control Protocol) socket, raw UDP (User Datagram Protocol) socket, SMTP (Simple Mail Transfer Protocol), and SMPP (Short Message Peer-to-Peer Protocol).

The path-independent interface 14 allows the file repository 13 to be accessed via a number of different data paths. For example, as illustrated in FIG. 1 the file repository 13 can be accessed by the end-user device 20 directly through the service provider access network 10 or via an indirect path through the service provider access network 10 and the internet 11. Under other circumstances the file repository 13 may be accessed through another private network (not shown). In some embodiments the file repository 15 may have only one access path in which case “path independence” may not be required.

As described generally above the application description files 15 contain a technology independent description of services to be provided in the form of software applications. More specifically, according to some embodiments of the invention the application description files 15 include a client presentation description, application data and an action set (i.e. an instruction set).

The client presentation description specifies how the service (software application) is presented to the user on the end-user device 20. In the specific case of a GUI (Graphical User Interface) presentation, the client presentation description could include items such as a description of the generic GUI components, layout and color scheme.

The application data includes data that is required by the service so that it is functional. Image and audio files, that are possibly compressed, are examples of application data that may be associated with a new service.

The action-set (or instruction set) provides a set of possible commands that execute the functions associated with a particular service. In some embodiments of the invention some of the commands are directly executable by an end-user while others are executed in response to other internal or external stimuli.

Referring now to FIG. 2 with further reference to FIG. 1, according to some embodiments of the invention the end-user device 20 has a software architecture that includes a native OS (Operating System) 21, the network service client components 22, a thin client 24 and rendered software applications 27.

The native OS 21 is a software application that enables multiple other software applications to execute simultaneously on one hardware platform (e.g. a microprocessor within the end-user device 20). The native OS 21 is also responsible for hiding the implementation details of the hardware that makes-up the end-user device 20 from the service developers. In other words, the native OS 21 provides a software abstraction of the service capabilities that are possible given the underlying hardware and firmware of the end-user device 20. All of the other software applications that run on the end-user device 20 must inter-operate with the native OS 21.

The network service client components 22 are software applications that reside on the end-user device 20 that enable the end-user device 20 to subscribe to the service provider access network 10. With reference to FIG. 1, the network services 17, provided by the service provider access network 10, are invoked at the end-user device 20 through the use of the network service client components 22. In some embodiments the network service client components 22 exist as an installed client component software module. In other embodiments the network service client components 22 could be embedded in the hardware and/or firmware that make-up the end-user device 20.

The thin client 24 interprets and renders the application description files 15 into corresponding rendered applications 27 once they have been downloaded onto the end-user device 20. The thin client then binds the rendered applications 27 to the native OS 21 and the network service client components 22. The rendered applications 27 are software applications that implement services described in the application description files 15. The thin client 24 is made-up of an adaptive services API 31, software component libraries 33, and an abstraction layer 35.

The illustrated embodiment provides a thin client to perform interpreting, rendering and binding functions. More generally, in other embodiments of the invention application description files are interpreted, rendered, and the resulting software applications bound to underlying network service client components, using interpreting, rendering, and binding logic implemented in a suitable combination of one or more of hardware, software and firmware. The suitable combination of one or more of hardware, software and firmware is adapted to interpret, render and bind application description files on end-user devices. Various methods of obtaining the application description files 15 are discussed in detail below.

The adaptive services API 31 generally consists of a set of operational parameters that are used to link the thin client 24 and rendered applications 27 to both the native OS 21 and the network service client components 22 residing on the end-user device 20.

The software component libraries 33 include a number of generic pre-compiled software functions and feature sets. These generic pre-compiled software functions and feature sets can be combined in a number of ways to produce new and different software applications (i.e. the rendered applications 27). The software component libraries may not be required in embodiments where end-user devices include functions that can be invoked by downloadable services.

The abstraction layer 35 is also a software application. The abstraction layer 35 interprets and renders application description files producing the rendered applications 27 from the software component libraries 33 as a result. The rendered applications 27 are software applications that are linked to, and, thus have access to the underlying functionality available through the native OS 21, and, in some instances the network service client components 22.

In use, the thin client 24, upon receiving a particular application description file, renders the application description file as a user presentable application (i.e. the rendered application 27) residing and running on the end-user device 20. More specifically, abstraction layer 35, during the rendering process, first links together a number of the generic pre-compiled software functions and feature sets from the software component libraries 33 to produce a new rendered (software) application 27 that implements the service described in a particular application description file. The abstraction layer 35 then binds the new rendered application 27 into the native OS 21 and possibly the network service client components 22. Accordingly, when an end-user invokes one of the actions specified in the one of the rendered applications 27 the action invokes the network services 17 to which it is bound.

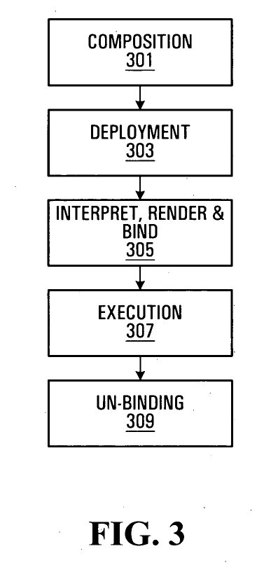

Some embodiments of the invention permit new services to have a life-cycle similar to that shown in the flow-chart provided in FIG. 3. Briefly, new services are developed and then dynamically added and removed from end-user devices. The services are described in application description files that are converted into software applications within an end-user device. The services can then be invoked from end user devices as though they were implemented as native software applications. However, when the end-user no longer requires or is no longer permitted to use a service the rendered software application can be removed from the end-user device. Advantageously, in some instances, this is an effective way to manage a limited memory resource in an end-user device.

Specifically, with reference to FIG. 3, the first phase in a service's life-cycle is the composition phase 301. The composition phase 301 is when a service designer creates the service. With further reference to FIG. 2, the service designer having knowledge of the capabilities of software component libraries 33 can design the service. It is important to note that the capabilities of the software components libraries 33 will be substantially similar for all types of end-user devices. That is, the capabilities of the thin clients for different vendors' API's will be substantially uniform. However, implementation of the generic pre-compiled software functions and feature sets that make up the software component libraries 33 will likely be substantially different for each operating system and/or set of manufacturer specific device protocols within end-user devices. The service designer can then compose one or more application description files associated with the new service.

The second phase of a new service's life-cycle is the deployment phase 303. With further reference to FIG. 1, in the deployment phase 303, the application description files 15 are stored on the file repository 13. The application description files 15 are then available to end-users that subscribe to the service provider access network 10. It is noted that the service provider can be an independent entity from the entity providing new applications.

The application description files 15 can be retrieved from the file repository 13 as required. File retrieval could either be initiated by a thin client on an end-user device or by the service provider.

For example, with further reference to FIG. 2, the thin client 24 could invoke the necessary network services 17 to download one or more of the application description files 15 based on some pre-determined logic or external stimulus. In this case the thin client 24 on the end-user device 20 can access the file repository 13 directly through the service provider access network 10 or indirectly through the service provider access network 10 and the internet 11. The application description files 15 can be downloaded using any one of a number of different protocols, such as HTTP, FTP, SIP and SMS.

In another example, a service provider or third-party service could act to “Push” application description files onto end-user devices in response to triggers which may include real-time changes in end-user status, location and/or privileges. A network-based service, provided either by the service provider or some third-party could download the application description files and send them directly to the thin client residing on an end-user device. This form of deployment can be facilitated using a number of network technologies such as SIP, SMS, or other “Push” technologies.

Referring back to FIG. 3, a third phase in a service's life-cycle is an interpreting, rendering and binding phase 305. Once an application description file has been received by a thin client, the application description file is interpreted, rendered into a user interface format (i.e. a software application residing on the end-user device), and bound to the network service client components 22 and the native OS 21.

A fourth phase in a service's life-cycle is an execution phase 307. As described above, one of the components of the rendered applications 27 is an action or a set of actions that can be invoked by the user. The actions (however many) are associated with functions of the network service client components 22 and the native OS 21 to which the rendered applications 27 are bound. By invoking a particular action the network services 17 required to carryout the higher level actions are automatically invoked.

A fifth phase in a service's life-cycle is an un-binding phase 309, in which a service may be dynamically removed for an end-user device. In other words, a rendered application that implements a service can be unbound and removed from the end-user device. This event could be a result of any number of possible events, such as, but not limited to, an explicit un-binding request by the end-user, an expiration of a particular time interval, a request to un-bind the application received from the network, a network event and/or shutting off the end-user device. Advantageously, these events could either occur in real-time, after a pre-defined duration of time or as a result of some other trigger event such as a real-time change in end-user status, location and/or privileges.

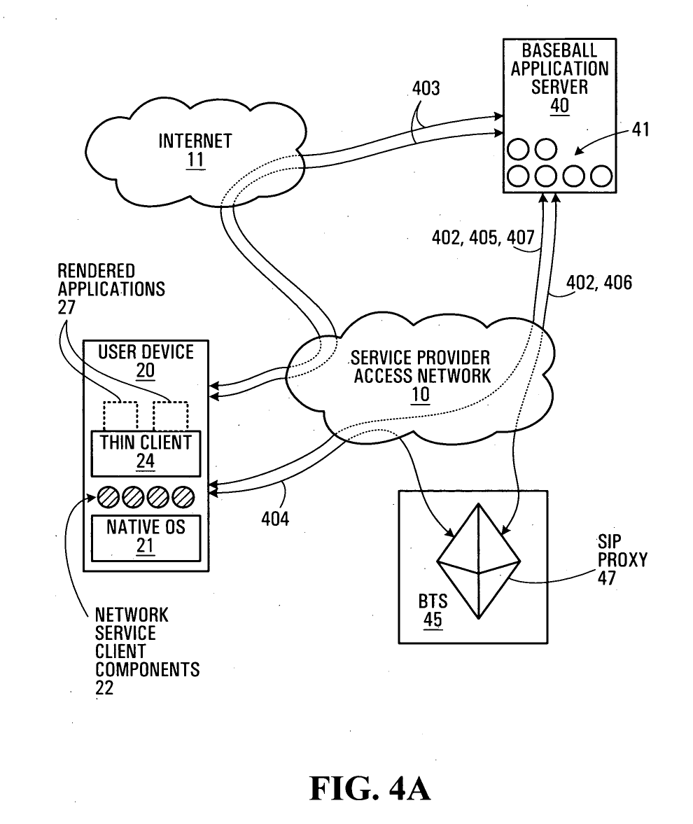

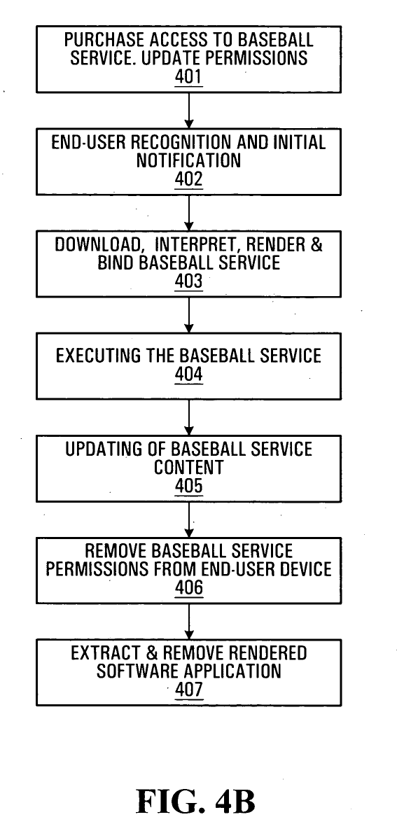

FIGS. 4A and 4B show a system illustration depicting a sequence of events for a service addition to an end-user device and a subsequent removal, and an associated flow chart, respectively, according to one specific embodiment of the invention. The system shown in FIG. 4A is similar to the communication system shown in FIG. 1 in that the system includes the end-user device 20, the internet 11 and the service provider access network 10. The file repository 13 shown in FIG. 1 has been replaced with a baseball service application server 40 shown in FIG. 4A. The network services 17 shown in FIG. 1 are embodied as a cellular wireless base-station 45 having a SIP Proxy 47 in FIG. 4A. This is only one very specific example of a new service that can be downloaded and it is not the intent of this example to in any way limit the scope of the invention. Moreover, it is to be understood that the SIP Proxy 47 is not limited to being co-located with a base-station or any other communication network element. In many instances a SIP Proxy resides in its own independent network element.

The system shown in FIG. 4A is used to deliver a baseball service 41 within a baseball stadium during a baseball game. That is, the system shown in FIG. 4A provides end-users having a device like end-user device 20 with additional content for the duration of baseball games while they are in the proximity of the baseball stadium. Access to the base-station 45 is included in an end-user's subscription to the service provider access network 10, which in this example includes a cellular wireless infrastructure. The baseball service application server 40 is also subscribed to the end-user device's 20 presence and location service capabilities provided by the service provider access network 10.

“Presence” is generally understood to be a combination of end-user availability, preferences for communication and connection-state. For example, if the end-user device 20 is not on, the connection-state is nil. Alternatively, the end-user device is on and the connection-state is logged-on; and, while logged-on the end-user may have wish to communicate with only a select few, as opposed to anybody that attempts to make a connection to the end-user device 20, such as in call-blocking.

Moreover, for sake of this example, it is assumed that the baseball stadium is located within the coverage area of the base-station 45. The baseball stadium provides the baseball service 41 through the use of ASE while the service provider access network 10 provides the infrastructure required to deliver Session Initiation Protocol (SIP) functionality via SIP proxy 47. If a baseball stadium resides in one or more coverage areas services by different respective base-stations, access to the baseball service application server 40 could be provided through any base-station to which the end-user-device 20 is in communication with.

The baseball service 41 is (a third party service) subscribed to the SIP Proxy 47 as an end-user so that it can make use of the SIP functions/services to communicate with other end-users, for example, through end-user device 20. The baseball service 41 is an example of a service that is to last only for a short period of time (i.e. during a baseball game) and within a specified geographic area (i.e. inside the coverage area 45 in and around the baseball stadium). The baseball service 41 can be either pushed or pulled onto the end-user device 20 through the SIP Proxy 47 in the base-station 45.

With reference to both FIGS. 4A and 4B, as a first step 401 it is recognized that the end-user of end-user device 20 can only have access to the baseball service 41 once a ticket to a baseball game is purchased. That is, at some point the baseball service application server 40 is made aware that the end-user of end-user device 20 has permission to access the baseball service 41 when in the vicinity of the baseball stadium. For example, an end-user is provided with a pass-code or provides information at the point of purchase that is delivered to the baseball service application server 40; either of which is used to determine whether or not the end-user will be provided permission to access the baseball service 41.

This is an example of some end-users having distinct privileges with respect to access to a particular service in comparison to other end-users (that have not purchased tickets.) Alternatively, the baseball service 41 could be provided to all end-users, subscribing to the service provider access network 10 and in the vicinity of the baseball stadium, regardless of whether or not they purchased tickets to the baseball game.

When the end-user device 20 (presumably with the end-user) enters the baseball stadium, this is detected by BTS 45 and SIP Proxy 47 informs the baseball service application server 40 of the location of the end-user device 20, at step 402. In reply, the baseball service application server 40 sends the end-user device 20 a SIP message, which informs the end-user device 20 that it can now download the baseball service 41.

At step 403, the end-user device 20 communicates with the baseball service application server 40 and pulls (i.e. actively downloads) the application description files (e.g. written in an XML) that make-up the baseball service 41. The application description files are interpreted and rendered as described above with respect to FIGS. 1 and 2 to produce a rendered application 27 on the end-user device 20 that provides the baseball service 41.

At step 404, the end-user is then able to use the baseball service 41 during the duration of the baseball game. In a very specific example, the baseball service includes providing additional stadium contacts to an end-user for the duration of the baseball game, providing instant replays of events during the game, and providing the end-user with the additional ability to send messages to be displayed on the stadium's monitors/screens.

At step 405, during the course of the baseball game, the baseball service application server 40 can update, using the SIP Proxy 47, any of the downloaded content associated with the baseball service 41 on the end-user device 20. The new content, for example, could include game status updates, the latest replay footage and new games/questions/predictions.

At step 406, when the baseball game is over or the user leaves the proximity of the baseball stadium, the SIP Proxy 47 and/or the baseball service application server acts to end and remove the baseball service 41 rendered on the end-user device 20. In the case of the end-user leaving the stadium (with the end-user device 20), the SIP Proxy 47 informs the baseball service application server 40 that the end-user has left the proximity of the baseball stadium.

At step 407, the baseball service application server 40 sends a SIP message to the thin client 24, residing on the end-user device 20, instructing the thin client 24 to remove (un-bind) the baseball service 40 from the end-user device 20. That is, the rendered application 27 associated with the baseball service 41 is extracted and deleted.

In one example, an application description file can be composed in a form of xHTML, which is an XML. The following is an example of an application description file composed in xHTML that is part of the baseball service 41 described above with reference to FIGS. 4A and 4B:

<html>
<head>
<title> Stadium Display </title>
</head>
<body>
<form method=”local” action=”sendim”>
Display your message on the Stadium Display
<input type=”hidden” name=”uri”
value=”stadiumdisplay@nortelnetworks.com”>
<textarea col=”25” row=”2” name=”message”>
</textarea>
<input type=”submit” value=”send”</input>
</input>
</form>
</body>
</html>

This application description file can be rendered into a software application on end-user device 20. The software application would allow an end-user to enter a text message on the end-user device and have that text message displayed on the Baseball Stadium's Display. The text message would be delivered via the service provider access network 10.

The application description file shown above can be broken down into three parts. The first part is the client presentation description, the second is the application data and the third is the action set.

The client application includes the following:

```
    <title> Stadium Display </title>
and,
    Display your message on the Stadium Display
    <textarea col=”25” row=”2” name=”message”>
    </textarea>
and,
    <input type=”submit” value=”send”</input>
```

The above would result in presentation screen having a title “Stadium Display”. The presentation screen would contain a directive “Display your message on the Stadium Display” to the end-user, followed by a text input box with corresponding menu items or buttons entitled “submit” and “send” which are used to initiate the service/action by the end-user.

The application data includes the following:

<input type=”hidden” name=”uri”
value=”stadiumdisplay@nortelnetworks.com”>...
</input>

This line item is used to provide additional data that can be used by the underlying network service client components 22.

The action set includes the following:

<form method=”local” action=”sendim”>...</form>

This line item indicates that the corresponding rendered application is to be bound to the “sendim” function of the underlying network service client components 22. When the above noted menu items or buttons are selected/depressed by the end-user, the “sendim” network function is executed.

What has been described is merely illustrative of the application of the principles of the invention. Other arrangements and methods can be implemented by those skilled in the art without departing from the spirit and scope of the present invention. For example, those skilled in the art would appreciate that embodiments of the present invention can be adapted for use in various types of communication systems such as cellular wireless systems, optical systems, wireline systems, Local Area Networks (LAN's) and Wide Area Network's (WAN's).

1. A system comprising:
a file repository storing at least one application description file, the at least one application description file containing a description of at least one service; and
an end-user device adapted to provide access to communication services for an end-user, the end-user device adapted to download the at least one application description file from the file repository, the end-user device having underlying network service client components, and the end-user device having interpreting, rendering and binding logic that interprets and renders the at least one application description into a software application and binds the software application to underlying network service client components residing on the end-user device.

2. A system according to claim 1, wherein the end-user device is further adapted to operate within a service provider access network comprising at least one of a cellular wireless infrastructure, a wireline communication system infrastructure, an optical communication system infrastructure, a Local Area Network (LAN) communication system infrastructure and a Wide Area Network (WAN) communication system infrastructure.

3. A system according to claim 2 further comprising said service provider access network, wherein the service provider access network obtains the at least one application description file from the file repository and downloads the at least one application description file to the end-user device.

4. A system according to claim 3, wherein at least one of the end-user device, the service provider access network and the file repository is connectable to a private communication network so that the end-user device can access the file repository through the combination of the service provider access network and the private communication network.

5. A system according to claim 3, wherein at least one of the end-user device, the service access provider network and the file repository is connectable to an internet so that the end-user device can access the file repository through the combination of the service provider access network and the internet.

6. A system according to claim 1, wherein a trigger is used in a determination of whether or not the at least one application description file is to be downloaded to the end-user device.

7. A communication system according to claim 3, wherein a trigger is used by the service provider access network to determine whether or not the at least one application description file is to be downloaded to the end-user device.

8. A system according to claim 7, wherein the trigger is at least one of an end-user request, current status, location and privileges of a respective subscriber and/or end-user device.

9. A system according to claim 8, wherein the trigger is forwarded to the file repository in response to which the file repository downloads the at least one application description file to the end-user device.

10. A system according to claim 1, wherein for a subscriber having a respective end-user device, after the application description file has been downloaded and rendered into the corresponding software application, a trigger is used in a determination of whether or not a software application rendered from the at least one application description file is to be removed from the respective end-user device.

11. A system according to claim 10, wherein the trigger for the subscriber is at least one of an end-user request, current status, location and privileges of the subscriber.

12. A system according to claim 10, wherein the end-user device is further adapted to operate within a service provider access network comprising at least one of a cellular wireless infrastructure, a wireline communication system infrastructure, an optical communication system infrastructure, a Local Area Network (LAN) communication system infrastructure and a Wide Area Network (WAN) communication system infrastructure.

13. A system according to claim 12 further comprising said service provider access network, wherein the service provider access network obtains the at least one application description file from the file repository and downloads the at least one application description file to the end-user device.

14. A system according to claim 13, wherein the trigger is used by a service provider access network to determine whether or not the software application is to be removed to the end-user device.

15. A system according to claim 14, wherein the service provider access network signals the end-user device according to one of HTTP (HyperText Transfer Protocol), FTP (File Transfer Protocol), SIP (Session Initiation Protocol) and SMS (Short Message Service).

16. A system according to claim 1, wherein the end-user device further comprises:
a native Operating System (OS) serving as the operating platform for the end-user device; and
a receiver for receiving application description files through the communication system.

17. An end-user device for use in a communication system providing additional services through the use of respective application description files that contains descriptions of corresponding services, the end-user device comprising:
a native Operating System (OS) serving as the operating platform for the end-user device;
a receiver for receiving application description files through the communication system;
underlying network service client components that enable the use of network services on the end-user device; and
interpreting, rendering and binding logic that interprets and renders the application description files into corresponding rendered software applications, and then binds the rendered software applications to the underlying network service client components residing on the end-user device, the software applications providing the additional services on the end-user device.

18. An end-user device according to claim 17, wherein the interpreting, rendering and binding logic comprises an adaptive service Application Program Interface (API) that is made up a set of operational parameters that link the thin client and rendered software applications to at least one of the native OS and the network service client components.

19. An end-user device according to claim 17, wherein the interpreting, rendering and binding logic comprises software component libraries that are made-up of number of generic pre-compiled software functions and feature sets that can be combined in a number of ways to produce different software applications.

20. An end-user device according to claim 17, wherein the interpreting, rendering and binding logic comprises an abstraction layer for interpreting and then rendering the contents of application description files into rendered software applications and binding them to the native OS and the underlying network service client components.

21. An end-user device according to claim 20, wherein the abstraction layer is further adapted to un-bind rendered software applications from the native OS and the underlying network service client components when signalled to do so.

22. An end-user device according to claim 21, wherein the abstraction layer is further adapted to delete un-bound rendered software applications when signalled to do so.

23. A file repository for storing an application description file for access by an end-user device operable within a communication system and having interpreting, rendering and binding logic, and the file repository comprising a data structure stored in the file repository, the data structure including a description of a service for use in the communication system.

24. A file repository according to claim 23, wherein the data structure further comprises a client presentation description that specifies how the service is presented to an end-user on the end-user device.

25. A file repository according to claim 23, wherein the data structure further comprises an application data that is utilized in the execution of the service on the end-user device.

26. A file repository according to claim 23, wherein the data structure further comprises an action-set that provides a set of possible commands that execute functions associated with the execution of the service on the end-user device.

27. A file repository according to claim 23, wherein the data structure is composed in an extensible Mark-up Language (XML).

28. A computer readable medium for storing an application description file for access by an end-user device operable within a communication system and having interpreting, rendering and binding logic, and the computer readable medium comprising a data structure that includes a description of a service for use in the communication system.

29. A computer readable medium according to claim 28, wherein the data structure further comprises a client presentation description that specifies how the service is presented to an end-user on the end-user device.

30. A computer readable medium according to claim 28, wherein the data structure further comprises an application data that is utilized in the execution of the service on the end-user device.

31. A computer readable medium according to claim 28, wherein the data structure further comprises an action-set that provides a set of possible commands that execute functions associated with the execution of the service on the end-user device.

32. A computer readable medium according to claim 28, wherein the data structure is composed in an extensible Mark-up Language (XML).

33. A computer readable medium comprising processed readable instructions for execution by an end-user device, the instructions comprising interpreting, rendering and binding logic that interprets and renders the application description files into corresponding rendered software applications, and then binds the rendered software applications to underlying network service client components residing on the end-user device, the software applications providing the additional services on the end-user device.

34. A method of dynamically downloading and rendering a service within a communication system onto an end-user device, the method comprising:
the end-user device downloading an application description file, the application description file describing the service; and
the end-user device interpreting and rendering the application description file to produce a corresponding software application from software component libraries stored on the end-user device; and binding the corresponding software application to underlying network service client components residing on the end-user device enabling the use of the service on the end-user device.

35. A method according to claim 34 further comprising:
determining a trigger for the end-user device; and
permitting or denying the end-user device to download the application description file based on the trigger for the end-user device.

36. A method according to claim 35, wherein a communication network element of the communication system determines the trigger for the end-user device.

37. A method according to claim 35, wherein a third party service provider determines the trigger for the end-user device and forwards the trigger to the communication system.

38. A method according to claim 35, wherein the end-user device determines the trigger for the end-user device.

39. A method according to claim 35, wherein a communication network element of the communication system permits or denies the end-user device to download the application description file based on the trigger for the end-user device.

40. A method according to claim 35, wherein a third party service provider permits or denies the end-user device to download the application description file based on the trigger for the end-user device.

41. A method according to claim 35, wherein the end-user device permits or denies the end-user device to download the application description file based on the trigger for the end-user device.

42. A method according to claim 34 further comprising:
determining a trigger for the end-user device; and
sending the end-user device the application description file based on the trigger for the end-user device.

43. A method according to claim 34 further comprising:
transmitting a request for the application description file to the communication network element; and
sending the application description file to the end-user device.

44. The method according to claim 34 further comprising:
determining the a trigger for the end-user device; and
transmitting an message to the end-user device to delete the corresponding software application based on the trigger for the end-user device.

45. The method according to claim 44 further comprising:
the end-user device receiving the message; and
the end-user device deleting the corresponding software application so that the service is no longer available on the end-user device.
